(19) United States
(12) Patent Application Publication
(10) Pub. No.: US 2008/0318170 A1
(43) Pub. Date: Dec. 25, 2008

(54) Method of making an optical disc

(76) Inventors: Chih-Hsun Lin, Taipei County (TW); Fung-Hsu Wu, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/837,546

(22) Filed: Aug. 13, 2007

(30) Foreign Application Priority Data
Jun. 22, 2007 (TW) 096122614

(51) Int. Cl. G03C 5/00

(52) U.S. Cl. 430/324

(57) ABSTRACT

A method of making an optical disc is disclosed, in which, a flexible imprint mold is made from a fluid-state flexible silicone and has a reversal pattern of a first pattern on a surface. Also, a substrate is provided and has a second pattern on the surface with a semi-reflective layer deposited thereon. A dye or UV curable resin layer is formed on the semi-reflective layer. The flexible imprint mold is used to imprint the dye or UV curable resin layer and allowed to stay on it. After the dye or UV curable resin layer is cured, the flexible imprint mold is released from the cured dye or UV curable resin layer, such that the dye or UV curable resin layer has the first pattern.

### BACKGROUND OF THE INVENTION

1. Field of the Invention

The present invention relates to a method of making an optical disc, and particularly to a method of making a double-layer optical disc using a flexible imprint technology.

2. Description of the Prior Art

FIGS. 1-3 illustrate a conventional method of making a double-layer optical disc. As shown in FIG. 1, first, a recording layer 4 is formed on a substrate 2. A stamper substrate 6 is also provided. The surface of the stamper substrate 6 has a pit pattern. A replication layer 8 is coated on the pit pattern of the stamper substrate 6, such that the pit pattern can be formed on the face of the replication layer 8 contacting the stamper substrate 6. The replication layer 8 contains an ultra-violet light (UV light) curable resin. The surfaces having the pit pattern of the stamper substrate 6 and the substrate 2 are adhered together with an adhesive layer 10 to obtain a configuration as shown in FIG. 2. The adhesive layer 10 contains a UV curable resin. The adhesive layer 10 and the replication layer 8 are cured by irradiation with UV light 12. Thereafter, as shown in FIG. 3, the stamper substrate 6 is stripped from the replication layer 8 to retain the replication layer 8 adhered on the recording layer 4, such that the pit pattern on the surface of the stamper substrate 6 is transferred. A recording layer (not shown) is deposited on the pit pattern to form two recording layers on the substrate 2, obtaining a single-sided double-layer optical disc.

However, the conventional manufacturing process is complicated, and, moreover, the mold is made of hard material, usually silicon or nickel, and easily abraded, such that the cost is increased.

### SUMMARY OF THE INVENTION

One object of the present invention is to provide a method of making an optical disc to make optical discs conveniently and economically.

The method of making an optical disc according to the present invention comprises steps as follows. First, a first substrate is provided. A photo-resist layer is formed on the first substrate and the photo-resist layer is patterned such that a surface of the photo-resist layer has a first pattern. Next, the first pattern is coated with a fluid-state flexible silicone layer. The fluid-state flexible silicone layer is cured to form a cured flexible silicone layer. The cured flexible silicone layer is stripped from the photo-resist layer to serve as a flexible imprint mold having a reverse pattern of the first pattern on a surface thereof. Also, a second substrate having a second pattern on a surface thereof and a semi-reflection layer deposited on the second pattern is provided. The semi-reflection layer is coated with a first dye or UV curable resin layer having an upper surface. The reverse pattern of the surface of the flexible imprint mold is imprinted on the upper surface of the first dye or UV curable resin layer, and the flexible imprint mold is allowed to stay on the upper surface of the first dye or UV curable resin layer. The first dye or UV curable resin layer is cured. The flexible imprint mold is released from the cured first dye or UV curable resin layer, such that the upper surface of the cured first dye or UV curable resin layer has the first pattern. A reflection layer is formed on the cured first dye or UV curable resin layer. Finally, a protection layer is formed on the reflection layer.

In another aspect of the present invention, the method of making an optical disc comprises steps as follows. First, a first substrate is provided. A photo-resist layer is formed on the first substrate and the photo-resist layer is patterned such that a surface of the photo-resist layer has a first pattern. Next, the first pattern is coated with a fluid-state flexible silicone layer. The fluid-state flexible silicone layer is cured to form a cured flexible silicone layer. The cured flexible silicone layer is stripped from the photo-resist layer to serve as a flexible imprint mold having a reverse pattern of the first pattern on a surface thereof. Also, a plurality of second substrates each having a second pattern on a surface thereof and a semi-reflection layer deposited on the second pattern are provided. Thereafter, each second substrate is subjected to steps as follows. The semi-reflection layer is coated with a first dye or UV curable resin layer having an upper surface. The reverse pattern of the surface of the flexible imprint mold is imprinted on the upper surface of the first dye or UV curable resin layer, and the flexible imprint mold is allowed to stay on the upper surface of the first dye or UV curable resin layer. The first dye or UV curable resin layer is cured. The flexible imprint mold is released from the cured first dye or UV curable resin layer, such that the upper surface of the cured first dye or UV curable resin layer has the first pattern. A reflection layer is formed on the cured first dye or UV curable resin layer. Finally, a protection layer is formed on the reflection layer.

The method of making an optical disc according to the present invention utilizes nano-scaled flexible imprint technology to make a double-layer optical disc. Because the flexible imprint mold obtained, especially from PDMS, in the present invention has properties of flexibility and precision to rolling over, it may be used to replicate the pattern (such as a pit pattern) of the tracks and directly transfer the pattern to the recording surface of an optical disc having a dye or UV curable resin coated thereon conveniently and economically.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 illustrate a conventional method of making a double-layer optical disc; and

FIGS. 4-12 illustrate a preferred embodiment of the method of making an optical disc according to the present invention.

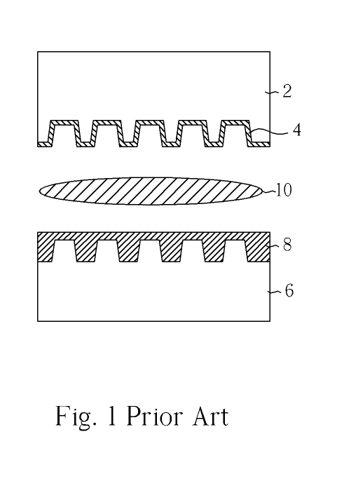

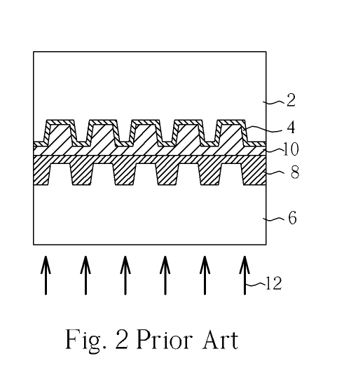

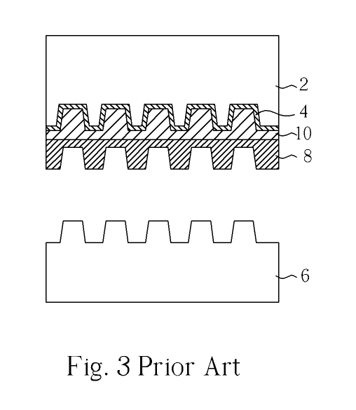

### DETAILED DESCRIPTION

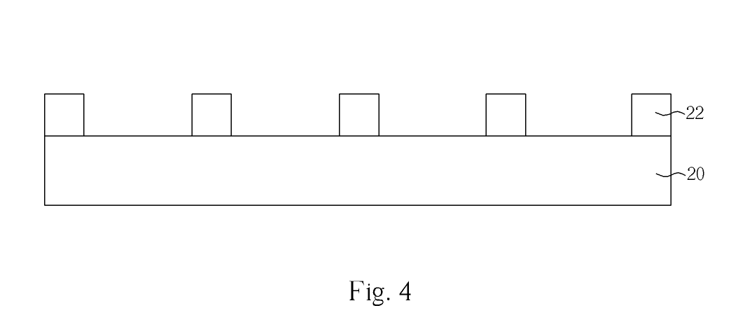

FIGS. 4-12 illustrate a preferred embodiment of the method of making an optical disc according to the present invention. First, a flexible imprint mold is made as follows. As shown in FIG. 4, a substrate 20 is provided. The substrate 20 may comprise a silicon substrate (wafer), a metal plate, a glass sheet, or the like. The thickness is not particularly limited. Thereafter, a photo-resist layer 22 is formed on the substrate 20 and a first pattern is formed on the surface of the photo-resist layer 22. The thickness of the photo-resist layer 22 may be for example 100 nm to 500 nm. Either a positive or a negative photo-resist may be used. The first pattern may be formed using an ion beam, a laser beam, an electron beam, a probe tip, or an optical fiber probe with a laser light transmitted therein to directly remove a part of the photo-resist layer 22. Alternatively, the first pattern may be formed by a photolithography process using an electron beam to expose a part of the photo-resist layer 22, followed by a development process, to form the first pattern. When an ion beam is used, ions, such as gallium ions (Ga⁺), are used to directly remove a part of the photo-resist layer to form a pattern. The first pattern may be the pit pattern of an optical disc, such as CD, CD-R, DVD, BD (blue disk) and the like.

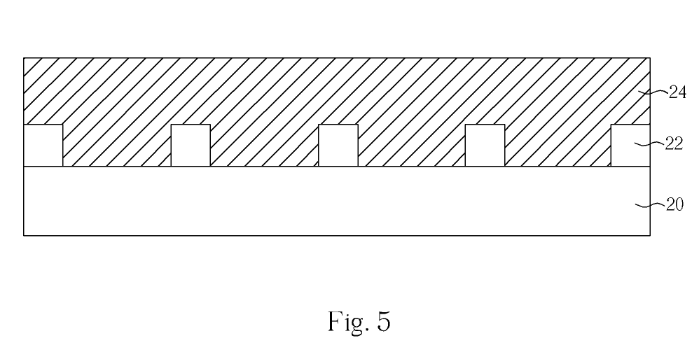

Thereafter, as shown in FIG. 5, the first pattern of the photo-resist layer 22 is coated with a fluid-state flexible silicone layer 24. A spin-coating process may be used to accomplish the coating, but not limited thereto. Since the fluid state is utilized, the process of coating is convenient and the fluid-state flexible silicone layer 24 is completely adhered to the photo-resist layer 22. Accordingly, an intact pattern with a high precision can be obtained. Thereafter, the fluid-state flexible silicone layer 24 is cured. The curing process may be performed by, for example, heating. The temperature is preferably less than 50° C., but not limited thereto. During the curing by heating, a proper pressure or vacuum can be simultaneously applied to improve the adhesion of the flexible silicone layer 24 with the photo-resist layer 22 (serving as an original mold), such that a pattern reverse to the pattern of the original mold (that is, the first pattern of the surface of the photo-resist layer 22) is formed on the flexible silicone layer 24. The flexible silicone layer 24 may have a high plasticity to obtain a good replication and a UV-light resistance, that is, it does not absorb UV light and thus the UV light can pass it, to avoid deterioration by UV light. For example, polydimethylsiloxane (PDMS) may be used with advantages of good result and inexpensiveness.

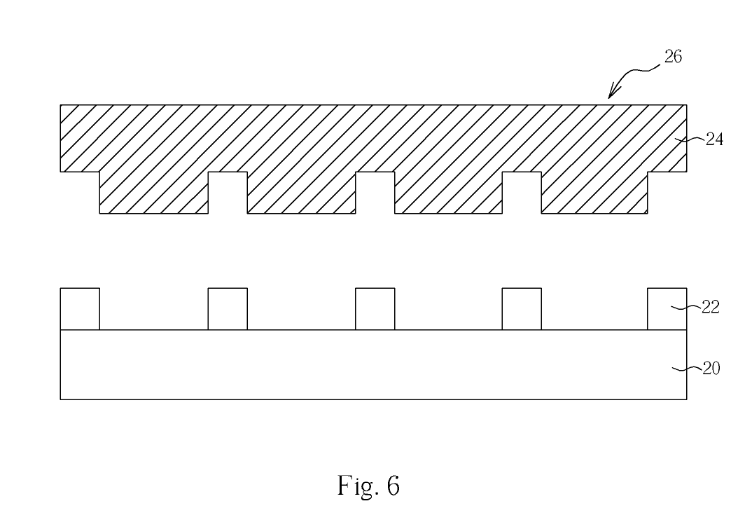

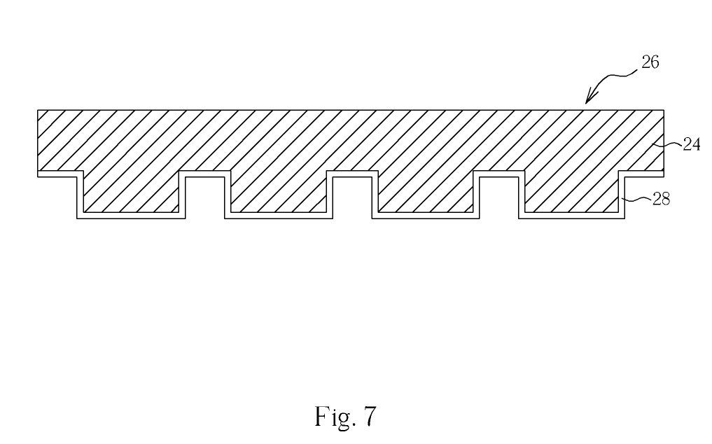

Thereafter, as shown in FIG. 6, the flexible silicone layer 24 becomes a solid and has flexibility favoring stripping after cured. With respect to PDMS, the photo-resist layer is easily separated from PDMS substantially without residue. The cured flexible silicone layer 24 is stripped from the photo-resist layer 22 to serve as a flexible imprint mold 26. A reverse pattern of the first pattern aforesaid is thus formed on the surface of the flexible imprint mold 26. The reverse pattern includes, for example, indents or protrusions reverse to the first pattern correspondingly. Please refer to FIG. 7. A releasing agent 28 may be optionally applied to the surface of the reverse pattern of the flexible imprint mold 26 to improve the subsequent mold releasing process. For example, the releasing agent may be applied by dipping the surface of the flexible imprint mold having the reverse pattern in a liquid or solution of a surfactant, or sputtering a metal layer or spin-coating a nano-film on the surface of the flexible imprint mold having the reverse pattern. The releasing agent may be for example a fluorine-containing releasing agent.

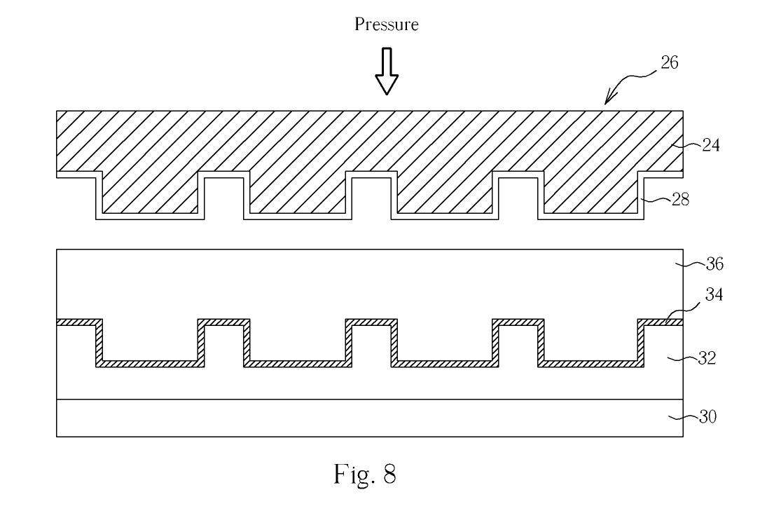

Thereafter, as shown in FIG. 8, a substrate 30 is provided. The substrate 30 may be a transparent blank plate made of, for example, polycarbonate (PC) resin or polymethylmethacrylate (PMMA). The thickness may be one as required, for example, 0.6 mm, 1.2 mm, 0.5 mm, or 0.3 mm, but not limited thereto. The substrate 30 further comprises a second pattern layer 32, such that the integrated substrate has a second pattern on the surface. Material of the second pattern layer 32 depends on the type of the optical disc. For example, it may be a dye layer for a recordable disc, or a UV curable layer for a ROM optical disc. The thickness may be conventional hundreds of μm. A semi-reflection layer 34 may be deposited on the surface of the second pattern layer 32. The semi-reflection layer 34 may comprise for example aluminum, silver, gold, copper, chromium, silicon, or an alloy thereof. The thickness may be for example 10 nm to 20 nm, and preferably 18 nm, but not limited thereto.

A dye or UV curable resin layer 36 is applied by, for example, spin coating, to the semi-reflection layer 34, and thereby the dye or UV curable resin layer 36 has an upper surface. The upper surface is preferably planar and uniform. The layer 36 may be a dye layer for a recordable disc, or a UV curable layer for a ROM optical disc. The thickness may be conventional hundreds or tens of μm, depending on product specifications or demands.

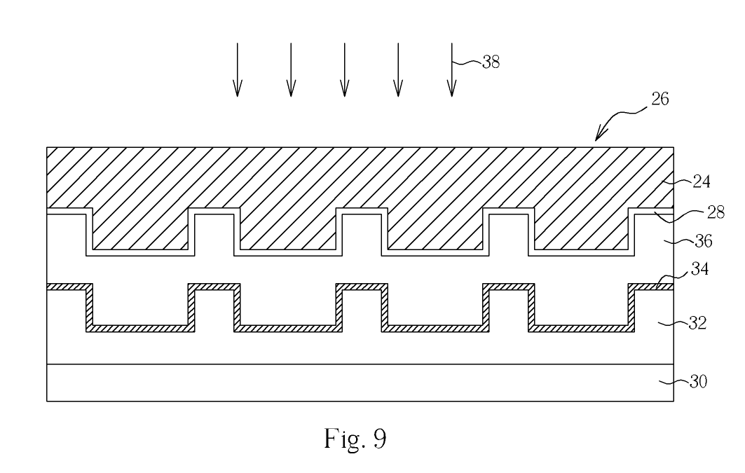

In this step, the dye or UV curable resin layer 36 has been formed on the semi-reflection layer 34 and has an upper surface. The reverse pattern of the surface of the flexible imprint mold 26 is imprinted under a proper pressure on the upper surface of the dye or UV curable resin layer 36, and the flexible imprint mold 26 is allowed to stay on the upper surface of the dye or UV curable resin layer 36. Accordingly, a reverse pattern is formed on the dye or UV curable resin layer 36, as shown in FIG. 9. Thereafter, the dye or UV curable resin layer 36 is cured by, for example, irradiation with UV light 38. During the irradiation with uniform UV light to cure the dye or UV curable resin layer 36, a proper pressure may be applied simultaneously to the dye or UV curable resin layer 36.

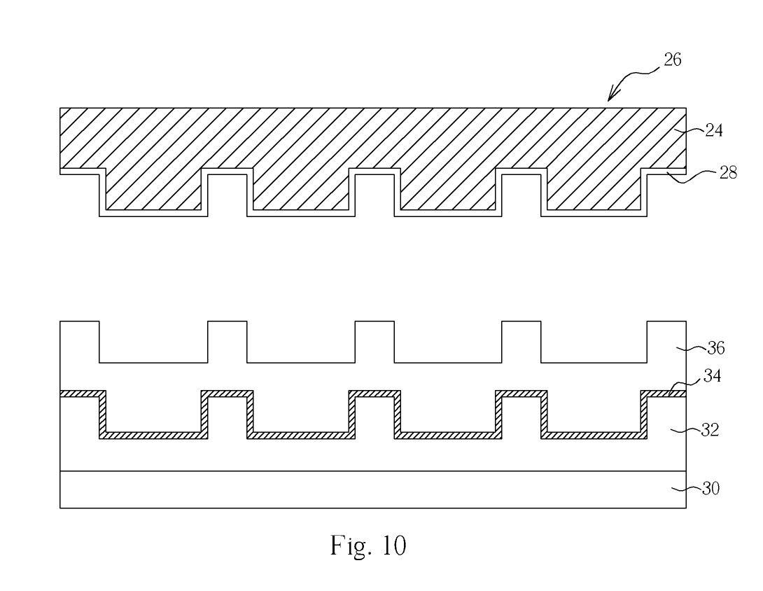

Thereafter, as shown in FIG. 10, the flexible imprint mold 26 is released from the cured dye or UV curable resin layer 36, such that the upper surface of the cured dye or UV curable resin layer 36 has the first pattern. Preferably, a proper releasing speed is used to release the flexible imprint mold 26 from the cured dye or UV curable resin. As such, two layers of pattern (that is, two recording layers) have been formed on the substrate 30.

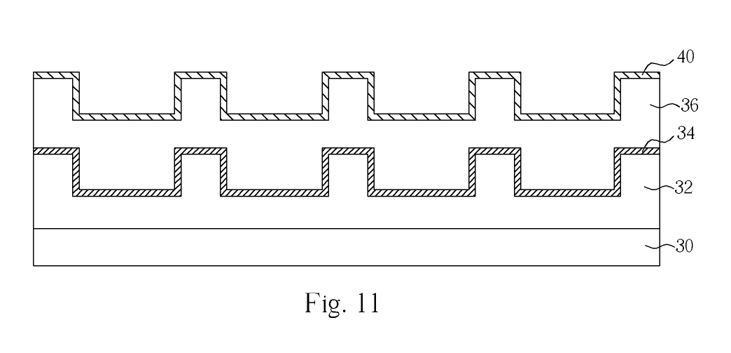

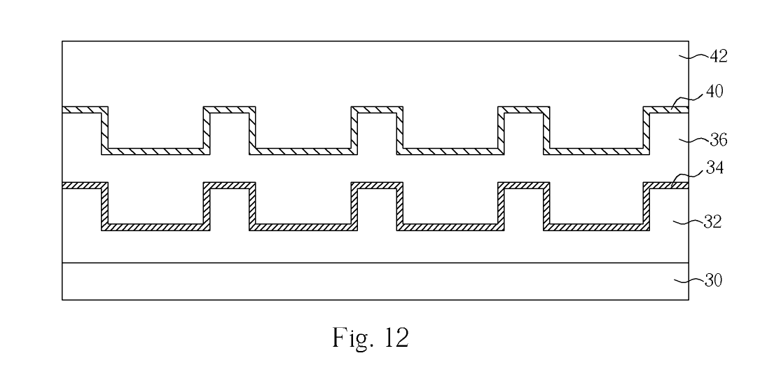

Thereafter, as shown in FIG. 11, a reflection layer 40 is formed on the cured dye or UV curable resin layer 36. For example, a sputterer may be used to sputter a reflection layer on the cured dye or UV curable resin layer 36. The reflection layer 40 may comprise for example aluminum, silver, gold, copper, chromium, silicon, or an alloy thereof. The thickness may be for example 18 nm, but not limited thereto. Finally, as shown in FIG. 12, a protection layer 42 is formed on the reflection layer 40 to form a double-layer optical disc. The protection layer 42 may be a scrape-resistant UV curable resin layer, which is cured upon irradiation with UV light, for protecting the dye or UV curable resin layer 36.

In the present invention, the flexible imprint mold is not easily abraded and can be repeatedly utilized. Accordingly, such flexible imprint mold may be used to repeatedly transfer the first pattern. That is, a plurality of double-layer optical discs may be obtained through repeatedly transferring the first pattern with one flexible imprint mold of the present invention aforesaid. In detail, a plurality of substrates each having a second pattern on a surface thereof, a semi-reflection layer on the second pattern, and a dye or UV curable resin layer on the semi-reflection layer are provided. By imprinting the upper surface of a dye or UV curable resin layer of each of the substrates with the reverse pattern of the surface of the flexible imprint mold and allowing the flexible imprint mold to stay on the upper surface of the dye or UV curable resin layer, the first pattern may be transferred to each of the substrates for making a plurality of double-layer optical discs.

Those skilled in the art will readily observe that numerous modifications and alterations of the device and method may be made while retaining the teachings of the invention.

What is claimed is:

1. A method of making an optical disc, comprising steps of:
providing a first substrate;
forming a photo-resist layer on the first substrate and patterning the photo-resist layer such that a surface of the photo-resist layer has a first pattern;
coating the first pattern with a fluid-state flexible silicone layer;
curing the fluid-state flexible silicone layer to form a cured flexible silicone layer;
stripping the cured flexible silicone layer from the photo-resist layer to serve as a flexible imprint mold having a reverse pattern of the first pattern on a surface thereof;
providing a second substrate having a second pattern on a surface thereof and a semi-reflection layer deposited on the second pattern;
coating the semi-reflection layer with a first dye or UV curable resin layer having an upper surface;
imprinting the upper surface of the first dye or UV curable resin layer with the reverse pattern of the surface of the flexible imprint mold and allowing the flexible imprint mold to stay on the upper surface of the first dye or UV curable resin layer;
curing the first dye or UV curable resin layer;
releasing the flexible imprint mold from the cured first dye or UV curable resin layer, such that the upper surface of the cured first dye or UV curable resin layer has the first pattern;
forming a reflection layer on the cured first dye or UV curable resin layer; and
forming a protection layer on the reflection layer.

2. The method of claim 1, wherein the flexible silicone layer comprises polydimethylsiloxane (PDMS).

3. The method of claim 1, wherein the step of curing the flexible silicone layer is performed using a heat curing process.

4. The method of claim 3, further comprising a step of applying a pressure onto the flexible silicone layer during the heat curing process.

5. The method of claim 1, wherein the step of coating the first pattern with the fluid-state flexible silicone layer is performed using a spin-coating process.

6. The method of claim 1, before the step of imprinting the upper surface of the first dye or UV curable resin layer with the reverse pattern of the surface of the flexible imprint mold, further comprising a step of applying a releasing agent to a surface of the flexible imprint mold having the reverse pattern.

7. The method of claim 6, wherein the step of applying the releasing agent is performed by sputtering a metal layer on the surface of the flexible imprint mold having the reverse pattern.

8. The method of claim 6, wherein the step of applying the releasing agent is performed by dipping the surface of the flexible imprint mold having the reverse pattern in a liquid or solution of a surfactant.

9. The method of claim 1, wherein the step of curing the first dye or UV curable resin layer is performed by irradiating the first dye or UV curable resin layer with UV light under a proper pressure applied to the first dye or UV curable layer to cure the first dye or UV curable layer.

10. The method of claim 1, wherein the step of forming the protection layer on the reflection layer is performed by coating the reflection layer with a UV curable layer and irradiating the UV curable layer with UV light to cure the UV curable layer.

11. The method of claim 1, wherein the step of patterning the photo-resist layer is performed by a photolithography process using an electron beam.

12. The method of claim 1, wherein the step of patterning the photo-resist layer is performed using an ion beam, a laser beam, an electron beam, a probe tip, or an optical fiber probe with a laser light transmitted therein to directly remove a part of the photo-resist layer.

13. The method of claim 1, wherein the second substrate comprises a polycarbonate (PC) substrate and a second dye or UV curable resin layer formed on the PC substrate, a surface of the second dye or UV curable resin layer has the second pattern.

14. The method of claim 1, wherein the first substrate comprises a silicon substrate, a metal plate, or a glass sheet.

15. A method of making an optical disc, comprising steps of:
providing a first substrate;
forming a photo-resist layer on the first substrate and patterning the photo-resist layer such that a surface of the photo-resist layer has a first pattern;
coating the first pattern with a fluid-state flexible silicone layer;
curing the fluid-state flexible silicone layer to form a cured flexible silicone layer;
stripping the cured flexible silicone layer from the photo-resist layer to serve as a flexible imprint mold having a reverse pattern of the first pattern on a surface thereof;
providing a plurality of second substrates each having a second pattern on a surface thereof and a semi-reflection layer deposited on the second pattern; and
performing steps as follows on each of the second substrate using the flexible imprint mold:
coating the semi-reflection layer with a first dye or UV curable resin layer having an upper surface;
imprinting the upper surface of the first dye or UV curable resin layer with the reverse pattern of the surface of the flexible imprint mold and allowing the flexible imprint mold to stay on the upper surface of the first dye or UV curable resin layer;
curing the first dye or UV curable resin layer;
releasing the flexible imprint mold from the cured first dye or UV curable resin layer, such that the upper surface of the cured first dye or UV curable resin layer has the first pattern;
forming a reflection layer on the cured first dye or UV curable resin layer; and
forming a protection layer on the reflection layer.
